(19) United States
(12) Patent Application Publication
(10) Pub. No.: US 2020/0118206 A1
(43) Pub. Date: Apr. 16, 2020

(54) System and Method for Automated Preferred Priority Lending

(71) Applicant: Duvera Billing Services, LLC d/b/a EasyPay Finance, Carlsbad, CA (US)

(72) Inventor: Scott Vertrees, Carlsbad, CA (US)

(73) Assignee: Duvera Billing Services, LLC d/b/a EasyPay Finance, Carlsbad, CA (US)

(21) Appl. No.: 16/599,202

(22) Filed: Oct. 11, 2019

Related U.S. Application Data
(60) Provisional application No. 62/744,208, filed on Oct. 11, 2018.

(51) Int. Cl. G06Q 40/02

(52) U.S. Cl. CPC G06Q 40/025

(57) ABSTRACT

Aspects of the disclosure relate to a prioritized approval of a loan amount. One or more processors may be configured receive a loan request including loan data representative of a borrower and a requested loan amount. The one or more processors may determine, based on the loan data a first decision indicating the loan request is approved in part, or not approved, by a first lender, and in response to the first decision and based on the loan data, a second decision indicating the loan request is approved in full or in part, or not approved, by a second lender. The one or more processors may provide an indication that the loan request is approved in full or in part, or not approved, based on the first decision and the second decision.

### CROSS-REFERENCE TO RELATED APPLICATIONS

This application claims the benefit of the filing date of U.S. Provisional Patent Application No. 62/744,208 filed Oct. 11, 2018, the disclosure of which is hereby incorporated herein by reference.

### BACKGROUND

The abundance of goods and services being sold today provides lenders with opportunities to offer loans for purchasing such goods and services. Generally, a consumer seeking a loan requests a loan from one source. The source then approves or rejects the loan request. If the loan is rejected, the consumer goes through the process again through another source for the loan. In such a case, even if only a portion of the loan amount was approved from one primary source, a consumer had to again go through the effort and hassle of seeking to obtain the remaining portion of the loan from other lenders.

Different creditor sources may also provide loans depending on varying credit scores. It is often difficult to provide loans to a consumer from several credit sources due to differences in credit score approval conditions. For example, a loan may not be approved for a consumer by a lender based on a particular credit score, yet another secondary lender may approve the loan based on the same credit score.

Thus, there is a need for a method and system that improves over existing lending systems that can provide a consumer with a fast and easy way to obtain loans, particularly in multiple parts, from a single point of entry or a single portal, based on a pool of multiple lender sources as described herein. A method and system for reliably identifying and selecting multiple lender sources to provide a consolidated single approval process for a full loan amount using a single consumer-facing system may be desirable to overcome problems and issues that exist in past systems that attempted to automate the loan process for consumers. In particular, there is need for a system and method for granting merchants a non-exclusive, perpetual, royalty-free license for use of a lending system and method that eliminates objection by primary sources partnering with a secondary or tertiary lender, as described herein. Such a system and method may also be offered free to merchants whereas existing third-party platforms charge fees that merchants may not be able to afford.

### SUMMARY

In today's competitive market for consumer purchases, whether in-store or online, it can be beneficial for retailers to offer financing solutions for goods or services to consumers. The ability of a retailer to offer a full financing solution with a single, easy-to-use interface or portal that can provide one loan decision in one system can be beneficial for the consumer and retailer. Such a system can also provide the benefit of a single retailer-branded credit application program that provides a borrower with a single loan application process such that the consumer-facing loan process is sponsored by the retailer. In this regard, the consumer need not be concerned with interfacing with different creditors and their respective different options and conditions. By providing a single loan application process through a retailer the consumer may not be subjected to the intricacies of the lending process, such as in the event a creditor opts not to provide credit or only opts to provide partial credit to the consumer, which may require additional sources of credit being sought.

Current solutions for loan systems using multiple lenders offered through an aggregator have drawbacks, including layers of costs associated with the loans. Additionally, during the course of obtaining loans from multiple sources from different places, there may be a lack of consistency in customer service. For example, a customer service representative from the aggregator that a borrower is provided with at the onset of the loan process may have to contact the customer service representative from the ultimate lender or lenders to solve the consumer's issue, leading to delays and uncertainty. This can add confusion and overall complexity to a situation involving obtaining a single loan or even multiple loans from different creditors.

Aspects of the present invention provide a technical, networked, system-wide solution to the difficulties of consumer lending as described above. From the perspective of the consumer or borrower, aspects of the present computerized priority lending system disclosed herein provide a one-stop, single-point source to a pool of lenders in order to provide a yes or no decision on multi-part loans that include partial loan amounts from more than one lender in order to fund a full requested loan amount. From the perspective of the lenders, the loan amount request may be presented in accordance with an order of lender priority, so that, in one embodiment, a first lender may have first priority over other lenders to fund the full amount, and then have the right to fund a partial amount of the loan, so that the preferred lender receives a right-of-first-refusal option to approve and provide the full loan or a partial amount of the loan before the system automatically moves on to other lenders sources to provide the full loan or a portion thereon.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIGS. 3 and 4 show example user interfaces of a computerized priority lending system in accordance with aspects of the disclosure.

FIGS. 5 and 6 show an example user interface including terms and conditions in accordance with aspects of the disclosure.

FIGS. 7-10 show a example user interfaces including credit application decisions in accordance with aspects of the disclosure.

FIGS. 11-12 are example flow diagrams in accordance with aspects of the disclosure.

FIGS. 13-14 are examples of datasets used by aspects of the disclosure.

### DETAILED DESCRIPTION

The following includes a description of exemplary aspects and modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

Aspects of the invention are herein described, by way of example only, with reference to the accompanying drawings. With specific reference to the drawings in detail, the particulars shown are by way of example and for purposes of illustrative discussion of preferred embodiments, and are presented in order to provide what is believed to be the most useful and readily understood description of the principles and conceptual aspects of the present invention.

The computerized automated preferred priority lending system allows lending to a consumer or borrower in an order of prioritized lenders. For example, a primary lender may obtain the loan request first, and then a secondary lender may be offered a loan opportunity automatically if the primary lender either rejects the borrower or agrees to provide a given portion of the entire requested loan amount. Likewise, in another embodiment, a third or tertiary lender can be offered to respond to a loan request if the full loan amount is not offered collectively by the primary and/or secondary lender, and so on down a priority chain of lenders.

In another aspect of the present invention, a computerized automated preferred priority lending system is fully customizable and branded to the merchant offering the goods or services to a borrower, with a merchant's trademarks, logos and/or color schemes such that the borrower is provided with a single loan application process and experience from the merchant, as opposed to needing to log into multiple different portals or websites of different lenders who are not branded as the merchant.

In yet another aspect of the present invention, a simple, single loan application is used by a computerized automated preferred priority lending system to provide a borrower's necessary information to all potential multi-tiered lenders for an instant decision without having to enter additional or different information as each loan decision is made by a different lender down the line.

In another aspect, if funding is declined by a preferred primary credit partner, or if it is approved by a preferred primary credit partner for less than the required finance amount, the borrower's information will be forwarded for decision by a second or third lender for approval for the full, or incremental, loan amount sought, as applicable.

In another aspect, the borrower will only experience a decline message if the approval is not offered by the system, which would include no loan being offered by the primary lender, or a partial loan offered by the primary lender where the remaining loan amount also is declined to be fulfilled by one or more secondary lenders by the computerized priority lending system, or, if the primary lender declines to fund any loan amount and the remaining secondary, tertiary, etc. lenders do not collectively fund, alone or in combination, the full loan amount.

In another aspect, a computerized automated priority lending system solution includes minimal integration requirements, providing a simple website or portal interface to receive all of the borrower's data and return the loan decision results—approved or not approved—on the same portal even though multiple lenders may be involved in providing portions of the entire loan amount.

In another aspect, analytical data regarding approvals at each stage of the borrower application process are made available to the merchant and the lenders, through a computerized priority lending system.

In another aspect, an automated computerized priority lending system provides a credit waterfall solution wherein the computerized priority lending system provides one portal to the borrower to obtain loans, in full or in part, where the credit providers offer multiple tiers of credit based on different credit score criteria. For example, the tiers of credit score criteria may include a lender who will lend in situations of bad credit and no credit approvals, which can increase the odds of full loan approval for the borrower, offered with appropriate rates and pricing. In another aspect, the computerized priority lending system offers lending on a national basis.

Another aspect of the invention provides a system. The system includes one or more computer processors that receives loan data which includes data representative of the borrower and a requested loan amount, and determines, based on the loan data received and on predetermined loan approval data criteria of at least two different lenders comprising a primary lender and a secondary lender, whether the loan will be approved in full or in part by the different lenders.

The system may include one or more processors that are operative to implement loan approval decisions based on the predetermined loan approval data. The loan approval decisions may include decisions where the loan is approved in part by the primary lender and in a remaining part by the secondary lender. The loan approval decisions may comprise a first approval decision for the primary lender, which may be either: to approve the request for the loan amount in full, to decline the request for the loan amount in full, or, to approve a first partial amount of the loan amount.

The loan approval decisions may comprise a second approval decision for the secondary lender when the primary lender approves the first partial amount of the loan amount. The second approval decision for the secondary lender may be either to approve the remaining amount of the loan amount, or to decline approval of the remaining loan amount.

In one embodiment of the system, the second approval decision by the secondary lender includes approving a second partial amount of the loan amount, which leads to a third approval decision for a third lender, which may be either to approve a third remaining amount of the loan amount, or to decline approval of the third remaining loan amount.

Another aspect of the invention provides a method of prioritized approval of a loan amount, which is performed by at least one computer processor that is programed to receive loan data that includes data regarding the borrower and a requested loan amount. The computer processor may determine, based on the loan data received and on predetermined loan approval data criteria of at least two different lenders comprising a primary lender and a secondary lender, whether the loan will be approved in full or in part by the different lenders.

In one example the processor may implement loan approval decisions based on the predetermined loan approval data, which may include decisions where the loan is approved in part by the primary lender and in a remaining part by the secondary lender. The decision may include a first approval decision for the primary lender that either: approves the request for the loan amount in full, declines the request for the loan amount in full, or approves a first partial amount of the loan amount.

The decision may also include a second approval decision for the secondary lender when the primary lender approves the first partial amount of the loan amount, which is either approves of the remaining amount of the loan amount, or a declines approval of the remaining loan amount.

In one embodiment of the method, the second approval decision by the secondary lender includes approving a second partial amount of the loan amount, which leads to a third approval decision for a third lender, which may be either to approve a third remaining amount of the loan amount, or to decline approval of the third remaining loan amount.

A further aspect of the invention provides a non-transitory, tangible computer-readable storage medium on which computer readable instructions of a program are stored. The instructions, when executed by one or more computing devices, cause the one or more computing devices to perform a method of a prioritized approval of a loan amount which is performed by at least one computer processor that may determine whether the loan will be approved in full or in part by the different lenders. The processor may implement loan approval decisions based on the predetermined loan approval data, which may include decisions where the loan is approved in part by the primary lender and in a remaining part by the secondary lender. The decision may include a first approval decision for the primary lender that either: approves the request for the loan amount in full, declines the request for the loan amount in full, or approves a first partial amount of the loan amount. The decision may also include a second approval decision for the secondary lender when the primary lender approves the first partial amount of the loan amount, which is either approves of the remaining amount of the loan amount, or a declines approval of the remaining loan amount. The second approval decision by the secondary lender may lead to a third approval decision for a third lender, which may be either to approve a third remaining amount of the loan amount, or to decline approval of the third remaining loan amount.

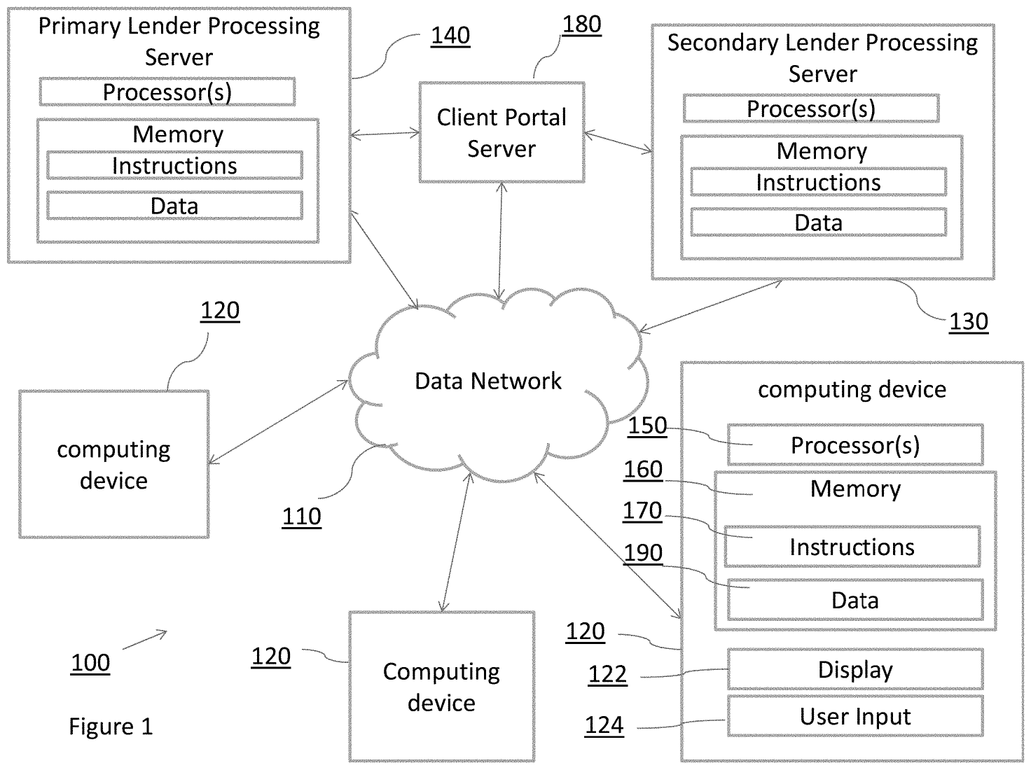

FIG. 1 provides an example system 100 in which the features described herein may be implemented. System 100 may include one or more computing devices 120, lender processing servers 130 and 140, and client portal server 170. Each of computing devices 120 may contain one or more processors 150, memory 160, input, output, displays, wired or wireless network connectors, and other components typically present in general purpose computing devices. Memory 160 of computing devices 120 may store information accessible by the one or more processors 150, including instructions 170 that may be executed by the one or more processors 150.

The computerized priority lending system may, in one embodiment, include a Client Portal Server 180, a Primary Lender Processing Server 140, a Secondary Lender Processing Server 130 and a data network 110. The Client Portal Server 180 may be connected to the Primary Lender Processing Server 140 and the Secondary Lender Processing Server 130, either directly or through wired or wireless networks such as a local area network or a global network such as the Internet. All of the servers can be discretely implemented and connected together and/or can be combined as one or more servers.

Memory 160 of the computing devices as well as the servers may also include data, such as data that may be retrieved, manipulated or stored by the processor. Such data may also be used for executing the instructions and/or for performing other functions. The memory may be of any non-transitory type capable of storing information accessible by the processor, such as a hard-drive, solid state hard-drive, memory card, ROM, RAM, DVD, CD-ROM, write-capable, read-only memories, and other such non-transitory types of memory.

The instructions may be any set of instructions to be executed directly, such as machine code, or indirectly, such as scripts, by the one or more processors. The instructions may be stored in any format which may be read and executed by the processor.

In some embodiments the instructions may be stored in a location separate from the computing device, such as in a remote network storage drive. The operations which the instructions cause the one or more processors to execute are explained in more detail below. The terms “instructions,” “functions,” “application,” “steps,” and “programs” may be used interchangeably herein.

The instructions may be stored in object code format for direct processing by a processor, or in any other computing device language including scripts or collections of independent source code modules that are interpreted on demand or compiled in advance. Data may be read and executed by the one or more processors in accordance with the instructions.

Data may be retrieved, stored or modified by the one or more processors in accordance with the instructions 170. For instance, although the subject matter described herein is not limited by any particular data structure, the data may be stored in computer registers, in a relational database as a table having many different fields and records, or XML documents. The data may also be formatted in any computing device-readable format such as, but not limited to, binary values, ASCII or Unicode. Moreover, the data may comprise any information sufficient to identify the relevant information, such as numbers, descriptive text, proprietary codes, pointers, references to data stored in other memories such as at other network locations, or information that is used by a function to calculate the other relevant information.

The one or more processors may be any conventional processors, such as a commercially available CPU from, for example, from Intel, AMD, or Apple. Alternatively, the processors may be dedicated components such as an application specific integrated circuit (“ASIC”) or other hardware-based processors, such as ARM processors or System on Chips (SoCs). Alternatively, the processors may be dedicated components such as an application specific integrated circuit (“ASIC”) or other hardware-based processor.

Although FIG. 1 functionally illustrates the processor, memory, and other elements of computing devices 120 as being within the same block, the processor, computer, computing device, or memory may actually comprise multiple processors, computers, computing devices, or memories that may or may not be stored within the same physical housing. For example, the memory may be a hard drive or other storage media located in housings different from that of the computing devices 120. Accordingly, references to a processor, computer, computing device, or memory will be understood to include references to a collection of processors, computers, computing devices, or memories that may or may not operate in parallel. For example, the computing devices 120 may include server computing devices operating as a load-balanced server farm. Yet further, although some functions described below are indicated as taking place on a single computing device having a single processor, various aspects of the subject matter described herein may be implemented by a plurality of computing devices, for example, communicating information over network 160.

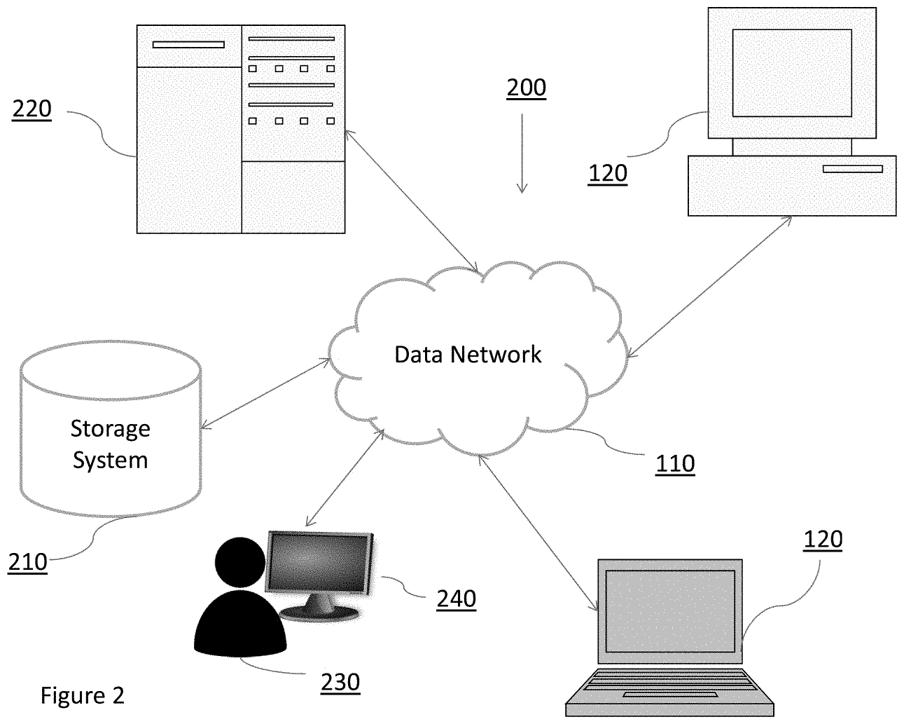

Each of the computing devices 120 may be at different nodes of a network 160 and capable of directly and indirectly communicating with other nodes of network 110. Although only a few computing devices are depicted in FIGS. 1-2, it should be appreciated that a typical system may include a large number of connected computing devices, with each different computing device being at a different node of the network 110. The network 110 and intervening nodes described herein may be interconnected using various protocols and systems, such that the network may be part of the Internet, World Wide Web, specific intranets, wide area networks, or local networks. The network may utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the servers may include web servers capable of communicating with one another via the network and communication with the computing devices that access the client portal server 180. For example, one or more computing devices 120 may use network 110 to transmit information to the user, and receive information from the user, such as user 230, on a display, such as display 122 of computing device 120. In this regard, computing devices 120, 130, and 140 may be considered user computing devices and may perform all or some of the features described herein.

Each of the user computing devices may include one or more processors, memory and instructions as described above. Each user computing device 120, 130 or 140 may be a personal computing device intended for use by a user 220 and have all of the components normally used in connection with a personal computing device such as a central processing unit (CPU), memory (e.g., RAM and internal hard drives) storing data and instructions, a display such as displays 122 (e.g., a monitor having a screen, a touch-screen, a projector, a television, or other device that is operable to display information), and user input device 124 (e.g., a mouse, keyboard, touch screen or microphone). The user computing devices may also include a camera for capturing still images or recording video streams, speakers, a network interface device, and all of the components used for connecting these elements to one another.

Although computing device 120 may comprise a full-sized personal computing device, they may alternatively comprise mobile computing devices capable of wirelessly exchanging data with a server over a network such as the Internet. By way of example only, computing device 120 may be a mobile phone or a device such as a wireless-enabled PDA, a tablet PC, or a netbook that is capable of obtaining information via the Internet. In another example, computing device 120 may be a head-mounted computing system. As an example the user may input information using a small keyboard, a keypad, microphone, using visual signals with a camera, or a touch screen.

As with memory 160, storage system 210 may be of any type of computerized storage capable of storing information accessible by the server 220 and computing device 120, such as a hard-drive, memory card, ROM, RAM, DVD, CD-ROM, write-capable, and read-only memories. In addition, storage system 210 may include a distributed storage system where data is stored on a plurality of different storage devices which may be physically located at the same or different geographic locations. Storage system 210 may be connected to the computing devices via the network 110 as shown in FIG. 1 and FIG. 2 and/or may be directly connected to or incorporated into the memory computing devices 120.

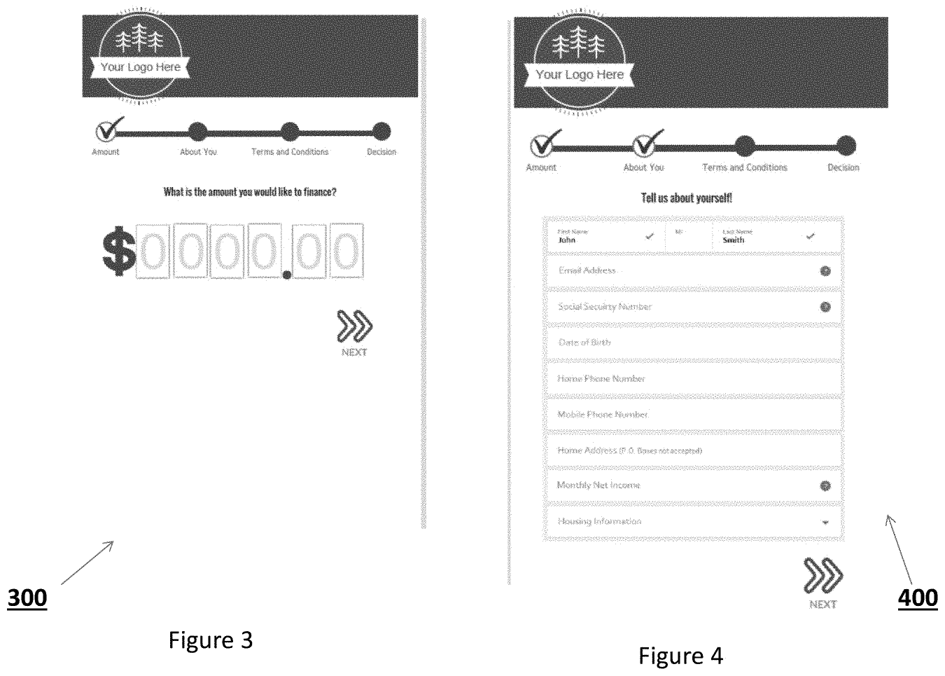

FIG. 3 and FIG. 4 show example screens on which an example a computerized priority lending system is displayed on a user device. In this example, the computerized priority lending system shows an easy 4-step loan approval process, though more or less steps can be used. In one example embodiment, as shown in screen 300 in FIG. 3, a borrower may begin the process by entering the desired amount to be financed. The borrower then progresses to the next step or screen, as shown in screen 400 in FIG. 4, which may include a fillable form in which to populate needed data or information about the borrower. In one example embodiment, a primary lender approves a partial amount of loan requested by the borrower in FIG. 3, and then the borrower is be presented with a Secondary offer for the remaining amount at a later point, and/or further down the priority waterfall.

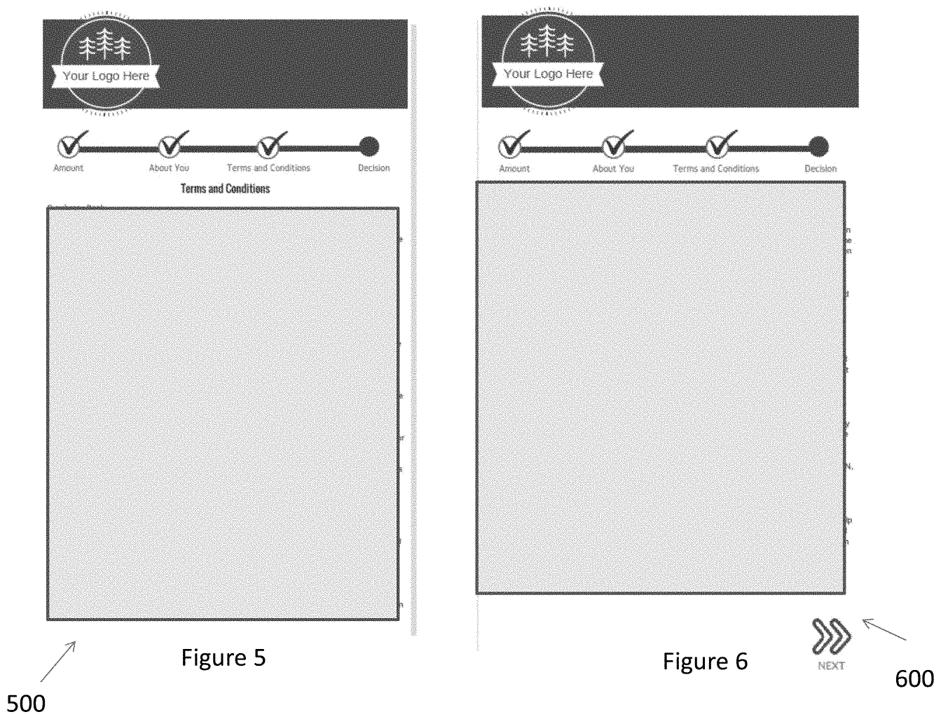

FIGS. 5 and 6 show an example of applicable Terms and Conditions that could be presented to the borrower. For example, the Terms and Conditions would begin on the screen 500 shown in FIG. 5, and continue on to the next page on the screen 600 shown in FIG. 6. On the bottom screen 600 the borrower may be provided with an option to accept the Terms and Conditions. The borrower may then select the “Next” button to continue the application process. At the next step of the application process, Application Disclosures will be sent to the corresponding lenders based on priority.

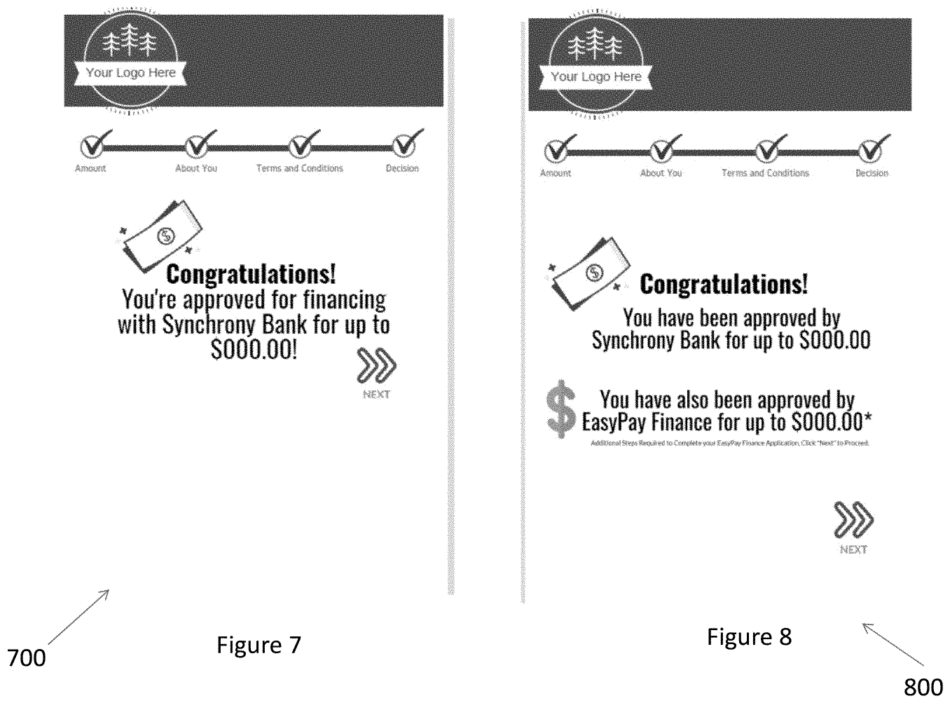

FIG. 7 shows an example screen 700 where a credit application decision is displayed to the borrower, where the primary lender has approved the borrower for the full amount requested by the borrower. In one aspect of the invention, the borrower can then be redirected to the primary lender's own separate web portal.

FIG. 8 shows an example screen 800 where a credit application decision is displayed where the primary lender has approved the borrower for the partial amount of the loan amount requested by the borrower. Here, the borrower can then be given the option to proceed with subsequent automated request to a secondary lender for the remaining amount. In one exemplary embodiment, a borrower agrees up front to have credit pulled from multiple lenders, and the secondary/tertiary credit decision is made without requiring borrower to say yes/no during the process. In one example, if the borrower selects “no” and refuses the option to proceed to a secondary lender for the remaining amount of the loan, the borrower may be routed or directed to the example screen shown in FIG. 7 showing approval for only up to a certain amount that is less than the full loan amount requested. At that point, the borrower may opt to pay any remaining amount via cash, check or other accepted tender by the merchant. In another example, if the borrower selects “yes” or agrees to the option of automatically proceeding to request a secondary lender for the remaining amount of the loan. If the remainder amount is approved by the secondary lender, the borrower will be informed by the screen of FIG. 8, which shows the first amount of the loan approved by the primary lender, and the remaining amount of the full loan as approved by the secondary lender. Optionally, the borrower may be routed or directed to the secondary lender's portal, which is connected to the secondary lender processing server 130 for further information needed by the secondary lender that may differ from the primary lender. Preferably, the borrower never has to leave the client portal and the decision on the loan is seamless and in one portal or interface.

In one example embodiment, the remaining loan amount to request a secondary lender could be set to be above a certain threshold loan amount. For example, the remainder of the loan could be set to a minimum of $350 in order to be acted upon by the secondary lender.

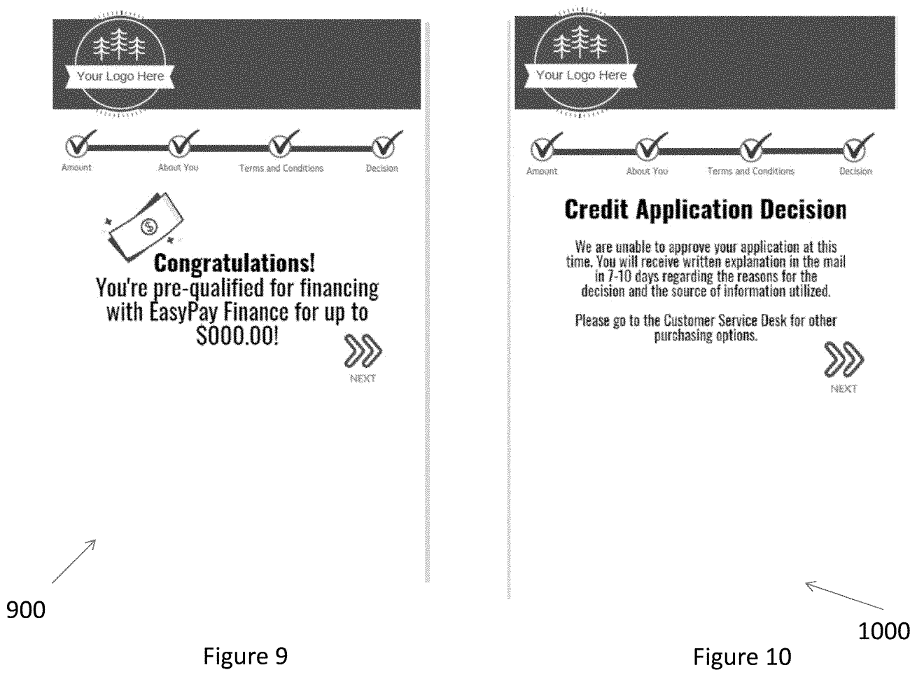

FIG. 9 shows an example screen 900 where the primary lender has declined the full loan or a partial amount of the loan, or an amount in excess of the amount requested by borrower.

The approvals for the secondary loans and loan amount are preferably pre-qualification approvals to be full approvals once all of the additional information requested is provided by the borrower.

FIG. 10 shows an example screen 1000 where the borrower has been declined by the primary lender as well as all secondary lenders.

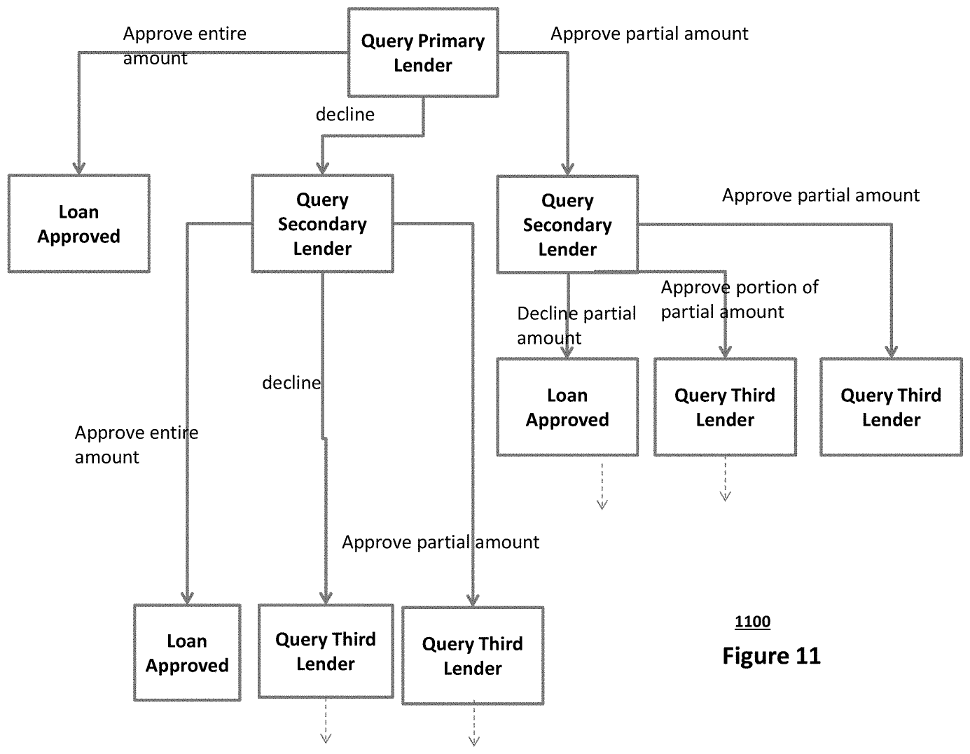

In FIG. 11, an example decision tree 1100 is provided for an exemplary embodiment of the present invention. As FIG. 11 shows, a primary lender, having right-of-first-refusal, is first queried for approval of the loan amount. The primary lender may approve the entire amount, decline, or approve the partial amount. If the primary lender approves the entire amount, the loan is approved, and the final decision is made by the primary lender. If the primary lender declines or approves a partial amount, and secondary lender is queried for the remaining loan amount. In each case, the secondary lender may approve the remaining amount, decline, or approve part of the remaining amount, or an amount in excess of that requested by borrower. Again, if the secondary lender approves the remaining amount, the final decision is made by a combination of the first and secondary lenders. If the secondary lender declines or approves only part of the entire remaining amount, a third lender is queried to provide the remaining loan amount. The decision tree may continue to a fourth, fifth, or six, etc., lenders.

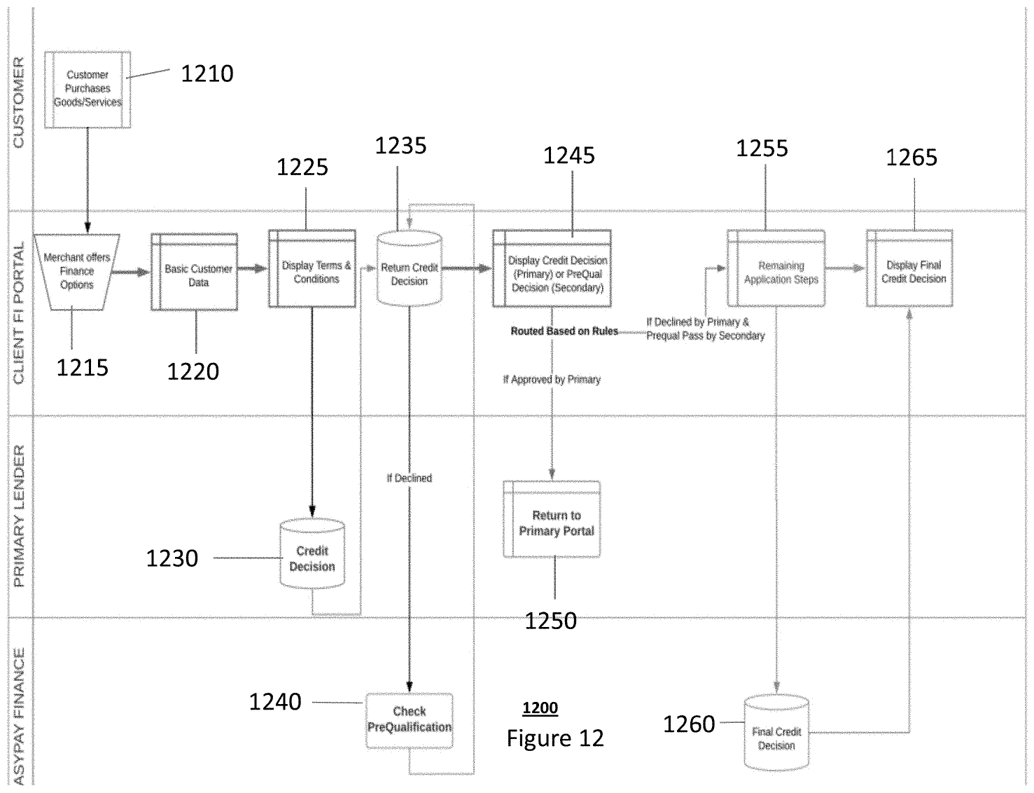

FIG. 12 shows a flow chart 1200 as an exemplary embodiment of the present invention. First, as step 1210 shows, the borrower purchases (or desires to purchase) goods and/or services from a merchant, or an online retailer, at which point, as shown in step 1215, the merchant may offer to the borrower loan options at the client portal which can be connected to one of the computing devices 120 as shown in FIG. 1. The borrower need not purchase the goods or services ahead of time and can make online decisions prior to any store visit or direct online purchases as well as direct loans for any use. Next, as shown by step 1220, the borrower is asked to input borrower data or other borrower information to the client portal via the computing device. Next, as shown by step 1225, the client portal provides the terms and conditions to be displayed on the computing device, and the borrower is asked to review and accept terms and conditions. Next, shown by step 1230, the data and loan request is sent via the client portal to the primary lender processing server 140, to allow the primary lender to make a credit decision and return the credit decision to the client portal.

As shown by step 1235, a credit decision is returned at the client portal. Next, as shown by step 1240, if the full amount of the loan is not approved, a secondary lender reviews and checks the borrower data to prequalify the borrower for the full requested loan amount. Next, as shown in step 1245, the credit decision of the primary lender or the pre-qualification decision of the secondary lender is displayed at the client portal.

Based on the loan data or rules of prioritization, or any other rules set by the one or more processors, the loan amount may be approved by the primary lender or declined by the primary lender. If the loan amount is approved by the primary, as shown by 1250, the user is returned to the primary portal. If the loan amount is declined by the primary, and the prequalification is passed by the secondary lender, the user is prompted to complete the remaining application steps, as shown by 1255.

After the remaining application steps are completed, a final credit decision is made at the secondary lender, shown by step 1260. At the same time, the final credit decision is displayed at the client portal, shown by step 1265.

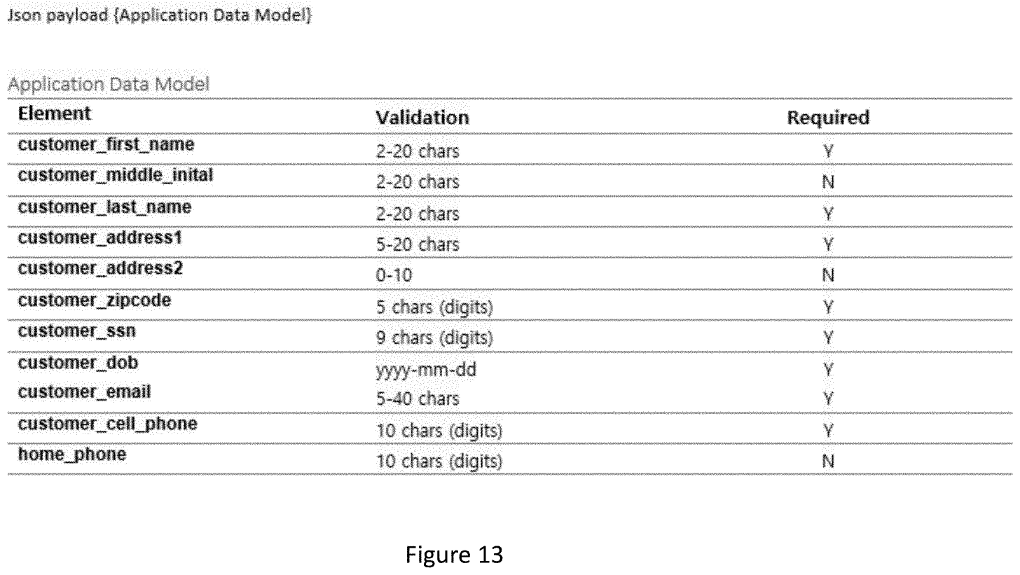

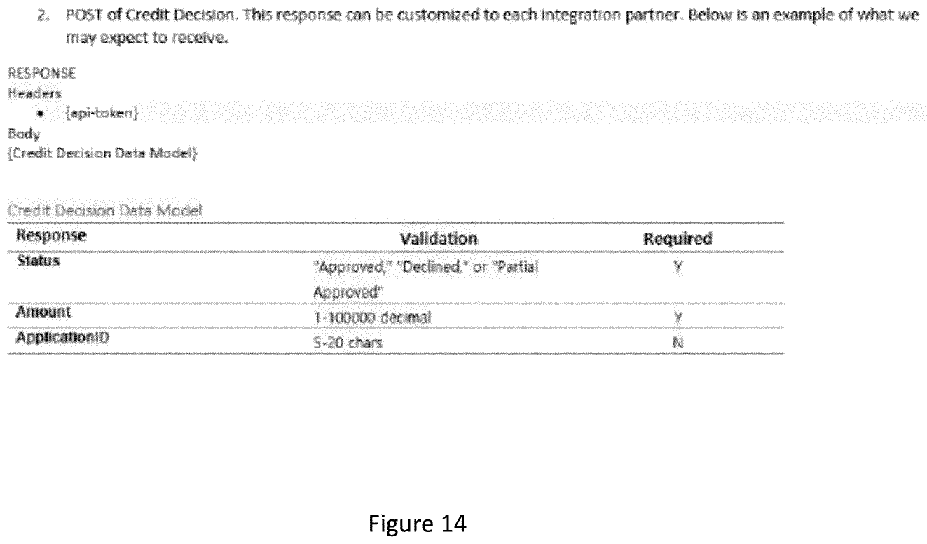

FIGS. 13 and 14 illustrate an example embodiment of data sets for an application data model, which, for example, allows lenders to support a computerized priority lending system over a REST API via HTTPS web requests. In one embodiment, the REST API Endpoint of the desired Primary Lender is used to begin the web request. In one embodiment, the security of the connection may be ensured by exchanging API Keys to authenticate an API call. In one possible embodiment, communication may occur across this connection.

FIG. 13 shows example data sets used in calls that may be made using GET of borrower data. In one example embodiment, an endpoint is to be determined.

FIG. 14 shows one of two calls that may be made using following the credit decision. In one example embodiment, this response may be customized to each integration partner. FIG. 14 may display an example of what integration partners may expect to receive.

Although the invention herein has been described with reference to particular aspects and embodiments, it is to be understood that these aspects and embodiments are merely illustrative of the principles and applications of the present invention. It is therefore to be understood that numerous modifications may be made to the illustrative embodiments and that other arrangements may be devised without departing from the spirit and scope of the present invention.

1. A computer-implemented method for prioritized approval of a loan amount, the method comprising:
receiving, by one or more processors, a loan request including loan data representative of a borrower and a requested loan amount;
determining, by the one or more processors, based on the loan data a first decision indicating the loan request is approved in part, or not approved, by a first lender;
in response to the first decision, determining by the one or more processors, based on the loan data, a second decision indicating the loan request is approved in full or in part, or not approved, by a second lender; and
providing, by the one or more processors, an indication that the loan request is approved in full or in part, or not approved, based on the first decision and the second decision.

2. The computer-implemented method of claim 1, further comprising:
forwarding the loan request to the first lender, wherein determining the first decision includes receiving a lending decision from the first lender.

3. The computer-implemented method of claim 1, further comprising:
forwarding the loan request to the second lender, wherein determining the second decision includes receiving a lending decision from the second lender.

4. The computer-implemented method of claim 1, wherein the first decision is further determined based on predetermined loan approval data criteria of the first lender.

5. The computer-implemented method of claim 1, wherein the second decision is further determined based on predetermined loan approval data criteria of the second lender.

6. The computer-implemented method of claim 1, further comprising:
in response to the second decision, determining, based on the loan data and predetermined loan approval data criteria of a third lender, a third decision indicating the loan request is approved in full or in part, or not approved, by the third lender,
wherein providing the indication that the loan request is approved in full or in part, or not approved, is further based on the third decision.

7. A system for prioritized approval of a loan amount, the system comprising:
one or more processors, wherein the one or more processors are configured to:
receive a loan request including loan data representative of a borrower and a requested loan amount;
determine, based on the loan data a first decision indicating the loan request is approved in part, or not approved, by a first lender;
determine, in response to the first decision and based on the loan data, a second decision indicating the loan request is approved in full or in part, or not approved, by a second lender; and
provide an indication that the loan request is approved in full or in part, or not approved, based on the first decision and the second decision.

8. The system of claim 7, wherein the one or more processors are further configured to:
forward the loan request to the first lender, wherein determining the first decision includes receiving a lending decision from the first lender.

9. The system of claim 7, wherein the one or more processors are further configured to:
forward the loan request to the second lender, wherein determining the second decision includes receiving a lending decision from the second lender.

10. The system of claim 7, wherein the first decision is further determined based on predetermined loan approval data criteria of the first lender.

11. The system of claim 7, wherein the second decision is further determined based on predetermined loan approval data criteria of the second lender.

12. The system of claim 7, wherein the one or more processors are further configured to:
determine, in response to the second decision and based on the loan data and predetermined loan approval data criteria of a third lender, a third decision indicating the loan request is approved in full or in part, or not approved, by the third lender,
wherein providing the indication that the loan request is approved in full or in part, or not approved, is further based on the third decision.

13. A non-transitory computer readable medium storing instructions, which when executed by one or more processors, cause the one or more processors to:
receive a loan request including loan data representative of a borrower and a requested loan amount;
determine, based on the loan data a first decision indicating the loan request is approved in part, or not approved, by a first lender;
determine, in response to the first decision and based on the loan data, a second decision indicating the loan request is approved in full or in part, or not approved, by a second lender; and
provide an indication that the loan request is approved in full or in part, or not approved, based on the first decision and the second decision.

14. The non-transitory computer readable medium of claim 13, wherein the instructions further cause the one or more processors to:
forward the loan request to the first lender, wherein determining the first decision includes receiving a lending decision from the first lender.

15. The non-transitory computer readable medium of claim 13, wherein the instructions further cause the one or more processors to:
forward the loan request to the second lender, wherein determining the second decision includes receiving a lending decision from the second lender.

16. The non-transitory computer readable medium of claim 13, wherein the first decision is further determined based on predetermined loan approval data criteria of the first lender.

17. The non-transitory computer readable medium of claim 13, wherein the second decision is further determined based on predetermined loan approval data criteria of the second lender.

18. The non-transitory computer readable medium of claim 13, wherein the instructions further cause the one or more processors to:
determine, in response to the second decision and based on the loan data and predetermined loan approval data criteria of a third lender, a third decision indicating the loan request is approved in full or in part, or not approved, by the third lender,
wherein providing the indication that the loan request is approved in full or in part, or not approved, is further based on the third decision.
